(19) United States
(12) Patent Application Publication
(10) Pub. No.: US 2008/0187277 A1
(43) Pub. Date: Aug. 7, 2008

(54) Lateral Emitting Optical Fiber and Light Emitting Device

(76) Inventors: Shinichi Irie, Tokyo (JP); Akihito Koga, Kanagawa (JP)

Correspondence Address: 3M INNOVATIVE PROPERTIES COMPANY, PO BOX 33427, ST. PAUL, MN, 55133-3427, US

(21) Appl. No.: 11/910,993

(22) PCT Filed: May 12, 2006
(86) PCT No.: PCT/US2006/018354

§ 371 Date: Oct. 9, 2007

(30) Foreign Application Priority Data
May 16, 2005 (JP) 2005-142456

(51) Int. Cl. G02B 6/02

(52) U.S. Cl. 385/123

(57) ABSTRACT

A lateral emitting optical fiber has a core material including a light transmitting resin capable of transmitting light entering from one end to the other end, and a clad material covering the periphery of the core material and having a lower refractive index than the core material, wherein the clad material includes a light transmitting resin and zinc oxide particles dispersed in the light transmitting resin.

### TECHNICAL FIELD OF THE INVENTION

The present invention relates to an optical fiber, and more specifically, it relates to a “lateral emitting optical fiber” wherein light introduced from at least one end in the direction of the core length is allowed to leak out through a clad in contact with the periphery (i.e. sides) of the core. The invention further relates to a light emitting device comprising the optical fiber.

BACKGROUND

Typical lateral emitting optical fibers belong to either types having a striped light-scattering reflection film adhering to a portion of the periphery of the core along the lengthwise direction of the core or types wherein a clad in contact with the core periphery includes light-scattering particles and light emitted from the core into the clad is scattered by the clad and leaks out.

The optical fiber of the first aforementioned type comprises, as a light-diffusing reflection film, a coating comprising a light-transmitting resin and light-scattering particles such as titanium dioxide dispersed in the resin, as disclosed in Japanese Unexamined Patent Publication SHO No. 60-118806, for example. The light-diffusing reflection film functions to diffusively reflect in the core, light which has passed through the core and reached the boundary between the reflection film and the core. This function of the light-diffusing reflection film and the lens function of the core act together to allow light to leak out with directional property in the direction transverse to the lengthwise direction of the core, thus allowing high-luminance emission across the full lengthwise direction. However, the light-diffusing reflection film described above generally has diffusing low light transmittance and cannot emit light in a wide visual angle (such as across the entire periphery) as can be achieved with neon tubes.

An optical fiber of the second aforementioned type is disclosed, for example, in Japanese Patent Specification No. 3384396. In the optical fiber disclosed in this publication, the fluoropolymer clad coating the core comprises 50-4000 ppm of titanium dioxide light-scattering particles. When the clad contains no light-scattering particles, a large proportion of the light which has passed into the core and reached the core-clad boundary is reflected at the boundary. However, inclusion such light-scattering particles in the clad causes light which has reached the core-clad boundary to be scattered. As a result, a portion of the scattered light is reflected toward the core while the rest leaks out through the clad to the outside. This function permits light emission at high luminance over the entire periphery of the fiber from light introduced through one end of the core.

Highly light transmitting acrylic resins are generally known as materials for cores, but such highly transparent resins are susceptible to degradation by ultraviolet sunlight, leading to yellowing and brittleness. The following methods have been adopted in order to prevent degradation of core materials.

1. The outside of the clad material is coated with a transparent resin containing an ultraviolet absorber.

2. The outside of the clad material is coated with an opaque resin comprising light-scattering bodies capable of blocking ultraviolet light.

3. Light-scattering bodies capable of blocking ultraviolet light are added to the clad material.

However, since Methods 1 and 2 above increase the number of manufacture steps and amount of material required, they are associated with increased cost. Method 3, on the other hand, is associated with the following problem.

Specifically, a fluorine-based resin with a low refractive index and high transparency is usually used as the clad material, but because fluorine-based resins have a high molding temperature it is common to employ inorganic-based light-scattering bodies, and especially titanium oxide. Titanium oxide is also mentioned in Japanese patent 3384396 referred to above, where it is used for lateral light emission, i.e., for the light-scattering bodies added to promote light leakage to the outside. However, if the titanium oxide content is excessively increased in order to improve the ultraviolet shield factor, light entering into the optical fiber is scattered to an extreme degree so that it leaks out of the clad immediately after entering, making it difficult to achieve uniformity of lateral luminance along the lengthwise direction of the optical fiber. In addition, excessively increasing the titanium oxide content to improve the ultraviolet shield factor also lowers the visible light transmittance, creating a problematic reduction in the absolute level of lateral luminance.

### SUMMARY OF THE INVENTION

According to the present invention a relatively large amount of zinc oxide particles is added into the clad, in place of conventional titanium oxide.

According to one mode, the invention provides a lateral emitting optical fiber comprising

a core material composed of a light transmitting resin capable of transmitting light entering from one end to the other end and a clad material covering the periphery of said core material and having a lower refractive index than said core material, said clad material comprising a light transmitting resin and zinc oxide particles dispersed in said light transmitting resin.

The invention further provides a light emitting device which comprises the aforementioned lateral emitting optical fiber, and a light source which introduces light from at least one end of the optical fiber.

The zinc oxide particles may be present at 0.15-30 wt % based on the weight of the clad material. The zinc oxide particles preferably have a particle size of 0.1-10 μm.

The “particle size” of the zinc oxide particles is a mean particle size measured by air permeation method.

### BRIEF DESCRIPTION OF THE DRAWINGS

FIG. 1 is a perspective view of an embodiment of an optical fiber of the invention.

FIG. 2 is a graph showing lateral luminance for the optical fibers of an example and comparative examples plotted against distances from the light source.

### DETAILED DESCRIPTION

According to the present invention it is possible to minimize ultraviolet degradation of an optical fiber core material by including zinc oxide particles. Since zinc oxide particles do not significantly lower the visible light transmittance, the optical fiber will still exhibit a high degree of luminance. In addition, since zinc oxide particles do not have excessive light-scattering power, light entering through the end of the optical fiber does not excessively leak out near the entrance. Therefore, a uniform degree of luminance can therefore be exhibited along the lengthwise direction of the optical fiber. As a result, the optical fiber of the invention can be used as a linear-shaped luminous body capable of substituting for neon tubes.

In the optical fiber of the invention, light-scattering zinc oxide particles are included in the clad. As a result, when light which has entered from one of the lengthwise ends passes toward the other end, the action of the light-scattering zinc oxide particles causes the light to leak out from the sides of the optical fiber, resulting in a lateral emitting optical fiber. Since the zinc oxide particles have lower light-scattering power than conventional titanium oxide particles, there is no excessive leakage of light even if the zinc oxide particles are added in a relatively large amount. Consequently, uniform light emission across the lengthwise direction can be achieved even with a relatively high zinc oxide particle content.

Moreover, since zinc oxide particles do not significantly lower the visible light transmittance, unlike conventional titanium oxide particles, the optical fiber can maintain a high degree of luminance even if the particles are added in a relatively large amount. In addition, the ultraviolet shield factor of the zinc oxide particles compared to conventional titanium oxide particles can inhibit ultraviolet degradation of the optical fiber core material. Thus, yellowing and similar degradation of the optical fiber can be avoided, thereby extending the usable life of the optical fiber.

The zinc oxide particles in the clad material are of an effective size to scatter light propagated in the optical fiber near the boundary between the clad material and core material. The zinc oxide particles preferably have a particle size of 0.1-10 μm. If the particle size of the zinc oxide particles is too large, the light-scattering power may be reduced. If the particle size of the zinc oxide particles is too large, an adverse effect may be exhibited on the processing and flexural strength of the clad. On the other hand, if the particle size of the zinc oxide particles is too small, the light-scattering power may also be reduced. From this viewpoint, the particle size of the zinc oxide particles is preferably 0.1-10 μm. The method of measuring the particle size is as explained above.

The clad material may also contain light scattering particles other than zinc oxide particles, as far as they do not detrimentally affect the effect of the present invention. Such light scattering particles are generally inorganic particles having a refractive index of 1.5 to 3.0, and for example, they can be particles of titanium oxide, magnesia, barium sulfate, calcium carbonate, silica, talc, wollastonite. The light scattering particles other than zinc oxide particles also have particle size similar to zinc oxide particles, and generally have particles size of 0.1 to 10 μm. The method of measuring the particle size is as explained above.

The zinc oxide particles are preferably present in an amount of 0.15-30 wt % based on the weight of the clad material. If the zinc oxide particle content is too high, the fluidity of the clad material will be poor and molding will be rendered more difficult. The clad material may be in a multilayer structure with different contents in each layer, but if the zinc oxide particle content of at least the innermost layer is too low, it may not be possible to achieve adequate luminance even with a high light source intensity (power consumption). The ultraviolet shielding and visible light transmissible properties based on the light scattering property of the zinc oxide particles depends not only on the wt % of the zinc oxide particles but also on the thickness of the clad material comprising the zinc oxide particles and other light scattering particles if present. Thus, the zinc oxide particle content should be determined based on the value of the wt % of the sum of the zinc oxide particles and light scattering particles other than the zinc oxide particles (hereinafter, referred to as “light scattering particles”) in the clad multiplied by the clad material thickness. Particularly when the clad material is an X-layered multilayer structure, the particle content should be determined by the value of Y as calculated by the formula below. From the standpoint of the ultraviolet shield factor, a small value for Y will lower the ultraviolet shield factor and may tend to promote ultraviolet degradation of the core material. A large Y value may lower the visible light transmittance and reduce the luminance. From this standpoint, the Y value is preferably 0.1-3.0 and more preferably 0.2-1.0.

Y=(wt % of light scattering particles in layer 1×thickness of layer 1 (mm))+(wt % of light scattering particles in layer 2×thickness of layer 2 (mm))+ . . . (wt % of light scattering particles in layer X×thickness of layer X (mm))

An optical fiber of the invention and its structural elements will now be explained in detail.

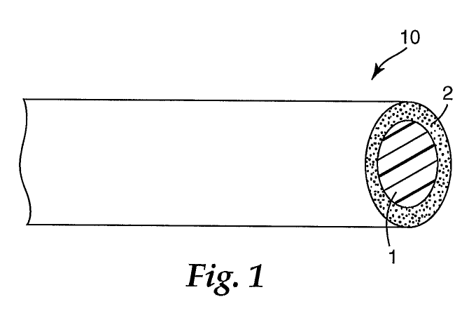

A preferred embodiment of an optical fiber of the invention will now be described with reference to FIG. 1. In the optical fiber 10, a clad 2 having a prescribed length is situated in direct contact with the outer periphery (peripheral side) of a light transmitting core 1. The length of the clad 2 corresponds to the length of the portion of the core 1 which is to emit the light, and normally it will be equivalent to the length from one end to the other of the core.

The refractive index of the core 1 will usually be in the range of 1.4-2.0. The material forming the core is, for example, a polymer-containing light transmitting material. The core form may be, for example, a solid core formed of a polymer material, or a liquid-encapsulating core having a liquid with a relatively high refractive index, such as silicone gel, encapsulated in a flexible plastic tube.

Polymer-containing light-transmitting materials for formation of the core such as acrylic polymers, polymethylpentene, ethylene-vinyl acetate copolymers, polyvinyl chloride and vinyl acetate-vinyl chloride copolymers may be used. The polymer used to form the core is preferably a methacrylic polymer. The refractive index of the polymer will usually be 1.4-1.7, and the total light ray transmittance will usually be 80% or greater. The polymer may also be crosslinked for increased heat resistant of the core itself.

A method of fabricating a solid core will now be explained. First, an acrylic monomer (a mixture of monomers or one monomer) as the core starting material is filled into a tube-shaped reactor extending in the lengthwise direction and having an opening on at least one end (preferably the “clad” of the optical fiber. The structure of the “clad” will be described hereunder). Next, the acrylic monomer is progressively heated at a temperature above the reaction temperature so that the acrylic monomer reaction takes place progressively from the other end of the container tube toward the opening end. That is, the heating position is shifted from the other end to the opening end. The reaction is carried out while pressurizing the acrylic monomer by pressurized gas in contact with the acrylic monomer. After completion of heating up to the opening end, the entire container tube is preferably heated for several more hours to thoroughly complete the reaction.

The acrylic monomer serving as the core starting material may be, for example, (i) a (meth)acrylate whose homopolymer has a glass transition temperature (Tg) above 0° C. (for example, n-butyl methacrylate, methyl methacrylate, methyl acrylate, 2-hydroxyethyl methacrylate, n-propyl methacrylate, phenyl methacrylate, etc.), (ii) a (meth)acrylate whose homopolymer has a Tg of below 0° C. (for example, 2-ethylhexyl methacrylate, ethyl acrylate, dodecyl methacrylate, dodecyl methacrylate, etc.), or a mixture of (i) and (ii). In the case of a mixture of (i) and (ii), the mixing weight proportion of the (meth)acrylate of (i) (H) and the (meth)acrylate of (ii) (L) (H:L) will normally be in the range of 15:85 to 60:40. A polyfunctional monomer such as diallyl phthalate, triethyleneglycol di(meth)acrylate or diethyleneglycol bisallyl carbonate may also be added to the mixture as a crosslinking agent. The term “(meth)acrylate” includes acrylates and/or methacrylates.

A peroxide thermal polymerization initiator such as lauroyl peroxide may be used for thermal polymerization of the acrylic-based monomer.

The acrylic-based core formed in the manner described above can form a polymer which is uniform from one end to the other in the lengthwise direction of the core, and exhibits satisfactory light propagation performance and sufficient mechanical strength against bending of the core itself.

The cross-sectional shape of the core in the widthwise direction (the direction orthogonal to the lengthwise direction) is not particularly restricted so long as the effect of the invention is not hindered. For example, it may be any geometric shape which can sustain flexibility of the core, such as a circle, ellipse, semi-circle, or arc with an area larger than a semi-circle. The core diameter is in the range of usually 1-40 mm and preferably 2-30 mm, where the widthwise cross-section is a circle.

The clad is fabricated, for example, by dispersing zinc oxide particles in a light-transmitting resin and forming resin pellets which are then melted and molded. In order to adjust the zinc oxide particle content in the clad, a resin containing no light-scattering particles may be mixed with the resin pellets. The molding apparatus used may be an extruder, for example. As explained above, the core starting material is injected into the hollow clad obtained in this manner and then polymerized to fabricate the optical fiber. The melted polymer for the clad and the melted polymer for the core may also be subjected to coextrusion molding to form the optical fiber.

The light-transmitting resin for the clad will generally be a resin material having a lower refractive index than the refractive index of the light-transmitting material for the core, and preferred examples for use are tetrafluoroethylene-hexafluoropropylene copolymer (FEP), tetrafluoroethylene-ethylene copolymer (ETFE) and tetrafluoroethylene-hexafluoropropylene-vinylidene fluoride copolymer (THV).

So long as the effect of the invention is not hindered, the clad may contain other additives in addition to the aforementioned material. Examples of suitable additives include crosslinking agents, ultraviolet absorbers, heat stabilizers, surfactants, plasticizers, antioxidants, antifungal agents, luminous materials, pressure-sensitive adhesives, tackifiers and the like.

The clad may have the thickness of ordinary clads used for lateral emitting optical fibers and is not particularly restricted, but the range of 100-800 μm is suitable.

According to the invention, since the clad contains zinc oxide particles and the particles reduce ultraviolet transmittance, there is no need for a protective layer around the periphery of the clad, and therefore durability can be maintained even with an optical fiber composed only of a core material and clad material. However, an additional layer may still be formed on the outer periphery of the clad if desired.

The optical fiber of the invention may be suitably utilized as a light-emitting device substituting for a neon light-emitting device. One mode of a light-emitting device according to the invention comprises a lateral emitting optical fiber of the invention and a light source which introduces light from at least one end of the optical fiber. While it is sufficient if the light is introduced from one end of the core, the light source is preferably situated so as to introduce light from both ends of the core. For example, the light source may consist of a first light source which introduces light from one end of the core and a second light source which introduces light from the other end of the core. By thus introducing light from both ends of the core, it is possible to further increase the uniformity of luminance. The same effect can be achieved by using a single light source, and using a separate light propagating means such as different optical fibers, for introduction of light from both ends of the core.

For illumination purposes, the length of the core coated with the clad will usually be in the range of 0.1-50 m, preferably 0.2-30 m and more preferably 0.3-15 m. The length may not be suitable for a linear-shaped light-emitting device if it is less than 0.1 m, while the uniformity of luminance across the entire length of the fiber may be reduced if it is greater than 50 m. The light source used may be an ordinary metal halide lamp, xenon lamp, halogen lamp, light-emitting diode, fluorescent lamp or the like. The power consumption of the light source will usually be in the range of 0.05-300 W.

### EXAMPLES

The present invention will now be explained in further detail by way of examples. It should be noted that the invention is in no way limited by these examples.

### Example 1

FEP100J (trade name) (DuPont) was loaded into a first extruder, and then FEP resin comprising zinc oxide particles (particle size=0.5 μm) dispersed therein at 29 wt % was loaded into a second extruder at 5.56 parts by weight with respect to 100 parts by weight of FEP100J (trade name). The resins were coextruded through a prescribed die, to obtain a tube-shaped double-layered clad material with an outer diameter of about 13 mm, comprising a light-transmitting resin layer with a thickness of about 317 μm as an outer layer and a light-dispersing resin layer with a thickness of about 138 μm as an inner layer.

For formation of the core material, 4 parts by weight of hydroxyethyl methacrylate, 96 parts by weight of n-butyl methacrylate and 1 part by weight of triethyleneglycol dimethacrylate were combined to prepare a monomer mixture. Next, 1.0 part by weight of lauroyl peroxide was added to the mixture as a thermal polymerization initiator to prepare a core precursor.

After introducing the core precursor from one end of the tube-shaped clad material, the end was sealed and thermal polymerization was conducted sequentially in a water tank from the sealed end while applying pressure from the other end with nitrogen, to form a solid core material. This yielded a lateral non-directional light-emitting optical fiber according to the invention.

The final outer diameter of the optical fiber was 13.7 mm, and the clad material thickness was 0.5 mm. The 183 μm inner layer portion of the clad material contained zinc oxide particles at 1.53 wt % based on the weight of the inner layer of the clad material. No light-scattering particles were present in the 317 μm outer layer portion of the clad material. The Y value of the optical fiber was 0.279.

### Example 2

Two extruders including a first extruder and second extruder were prepared, and FEP100J (trade name) (DuPont) was loaded into the first extruder and FEP resin having zinc oxide particles (particle size=0.5 μm) dispersed therein at 29 wt % was loaded into the second extruder at 5.56 parts by weight with respect to 100 parts by weight of FEP100J (trade name). The resins were coextruded through a prescribed die, to obtain a tube-shaped double-layered clad material with an outer diameter of about 13 mm, comprising a light-transmitting resin layer with a thickness of about 244 μm as an outer layer and a light-dispersing resin layer with a thickness of about 256 μm as an inner layer. An optical fiber was fabricated in the same manner as Example 1 except for using this clad material. The final outer diameter of the optical fiber was 13.7 mm, and the clad material thickness was 0.5 mm.

The 256 μm inner layer portion of the clad material contained zinc oxide particles at 1.53 wt % based on the weight of the inner layer of the clad material. No light-scattering particles were present in the 244 μm outer layer portion of the clad material. The Y value of the optical fiber was 0.391.

### Example 3

Two extruders including a first extruder and second extruder were prepared, and a mixture of 12.5 parts by weight of FEP resin having zinc oxide particles (particle size=0.5 μm) dispersed therein at 29 wt % combined with respect to 100 parts by weight of FEP100J (trade name) was loaded into the first extruder. Also, a mixture of 5.56 parts by weight of FEP resin having zinc oxide particles (particle size=0.5 μm) dispersed therein at 29 wt % combined with respect to 100 parts by weight of FEP100J (trade name) was loaded into the second extruder. The resins were coextruded through a prescribed die, to obtain a tube-shaped double-layered clad material with an outer diameter of about 13 mm, comprising a light-transmitting resin layer with a thickness of about 19 μm as an outer layer and a light-dispersing resin layer with a thickness of about 481 μm as an inner layer. An optical fiber was fabricated in the same manner as Example 1 except for using this clad material. The final outer diameter of the optical fiber was 13.7 mm, and the clad material thickness was 0.5 mm.

The 481 μm inner layer portion of the clad material contained zinc oxide particles at 1.53 wt % based on the weight of the inner layer of the clad material. Zinc oxide particles were also present in the 19 μm outer layer portion of the clad material, at 3.22 wt % based on the weight of the outer layer of the clad material. The Y value of the optical fiber was 0.795.

### Comparative Example 1

Two extruders including a first extruder and second extruder were prepared, and FEP100J (trade name) (DuPont) was loaded into the first extruder and the FEP resin NP20WH (trade name) (Daikin Kogyo) was loaded into the second extruder combined at 10 parts by weight with respect to 100 parts by weight of FEP100J (trade name). The resins were coextruded through a prescribed die, to obtain a tube-shaped double-layered clad material with an outer diameter of about 13 mm, comprising a light-transmitting resin layer with a thickness of about 250 μm as an outer layer and a light-dispersing resin layer with a thickness of about 250 μm as an inner layer. An optical fiber was fabricated in the same manner as Example 1 except for using this clad material. The final outer diameter of the optical fiber was 13.7 mm, and the clad material thickness was 0.5 mm. The NP20WH comprises titanium oxide particles dispersed at about 2.3 wt % in FEP resin, and therefore the 250 μm inner layer portion of the clad material contained titanium oxide particles at 0.21 wt % based on the weight of the inner layer of the clad material. No light-scattering particles were present in the 250 μm outer layer portion of the clad material. The Y value of the optical fiber was 0.525.

### Comparative Example 2

One extruder was prepared, and a mixture of NP20WH (trade name) (Daikin Kogyo) at 10 parts by weight with respect to 100 parts by weight of FEP100J (trade name) (DuPont) was loaded into the extruder and extruded through a prescribed die to obtain a single-layer tube-shaped clad material with an outer diameter of about 13 mm, comprising a light-scattering resin layer with a thickness of about 500 μm. An optical fiber was fabricated in the same manner as Example 1 except for using this clad material.

The final outer diameter of the optical fiber was 13.7 mm, and the clad material thickness was 0.5 mm. The NP20WH comprises titanium oxide particles dispersed at about 2.3 wt % in FEP resin, and therefore the 500 μm of the entire clad material contained titanium oxide particles at about 0.21 wt % based on the weight of the entire clad material. The Y value of the optical fiber was 0.105.

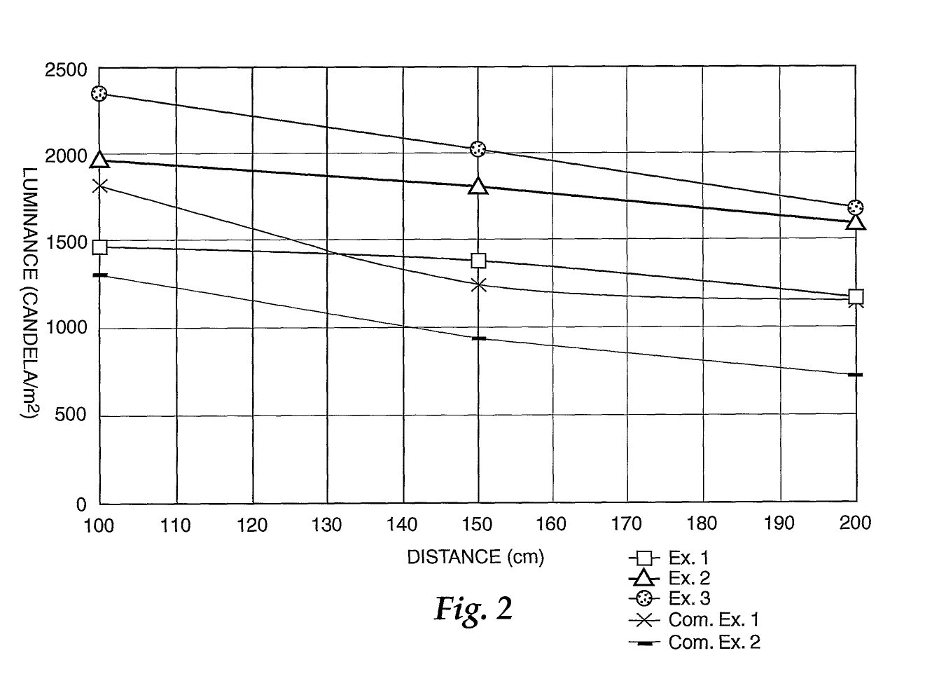

FIG. 2 shows the lateral luminance of optical fibers of the example and comparative examples. Each optical fiber was connected to an LBM130H (trade name) light source (Ushio Lighting), and the lateral luminance was measured at different distances from the light source using a Minolta CS100 (trade name) differential calorimeter. The light intensity of light entering the 13.7 mm optical fiber from the LBM130H (trade name) was 1200 lumens. Table 1 below shows the ultraviolet light transmittance (350 nm and 380 μm) and visible light transmittance (530 nm) of the clad materials used for the optical fibers of the examples and comparative examples. The light transmittances were measured at the different wavelengths using a Hitachi High Technologies UV-VIS Spectrometer (U-4100), with the clad material of each optical fiber cut into a 20 mm×20 mm sheet.

TABLE 1

| | Exam- | Exam- | Exam- | Comp. | Comp. |
|---|---|---|---|---|---|
| | ple 1 | ple 2 | ple 3 | Ex. 1 | Ex. 2 |
| Transmittance at 350 nm | 0.044 | 0.195 | 0.521 | 4.876 | 0.238 |
| wavelength (%) | | | | | |
| Transmittance at 380 nm | 0.403 | 1.715 | 2.799 | 6.657 | 4.43 |
| wavelength (%) | | | | | |
| Transmittance at 530 nm | 23.882 | 30.431 | 32.233 | 31.511 | 9.929 |
| wavelength (%) | | | | | |

The results in FIG. 2 demonstrate that an optical fiber according to the invention emitted light with greater luminance than the optical fibers of the comparative examples. The results in Table 1 show that optical fibers of the invention had lower ultraviolet transmittance than optical fibers of the comparative examples.

Examples 1-3 (zinc oxide clads) and Comparative Example 1(titanium oxide clad) exhibited approximately the same degree of visible light transmittance and lateral emission luminance, but Examples 1-3 had lower ultraviolet transmittance than Comparative Example 1. Also, although the ultraviolet transmittance was approximately the same in Examples 1-3 (zinc oxide clads) and Comparative Example 2 (titanium oxide clad), Examples 1-3 had higher visible light transmittance and lateral emission luminance compared to Comparative Example 2.

These results demonstrate that it is possible to realize satisfactory lateral emission luminance by filling the clad material with zinc oxide particles to a relatively high content, since the increased content does not significantly reduce visible light transmittance. In addition, since the zinc oxide particles can be filled into the clad material to a relatively high content, it is possible to reduce the ultraviolet transmittance and thus protect the optical fiber from the effects of ultraviolet rays.

What is claimed is:

1. A lateral emitting optical fiber comprising
a core material comprising a light transmitting resin capable of transmitting light entering from one end to the other end, and a clad material covering the periphery of said core material and having a lower refractive index than said core material, said clad material comprising a light transmitting resin and zinc oxide particles dispersed in said light transmitting resin.

2. A lateral emitting optical fiber according to claim 1, wherein said core material comprising a light transmitting polymer selected from the group consisting of acrylic polymers, polymethylpentene, ethylene-vinyl acetate copolymers, polyvinyl chloride and vinyl acetate-vinyl chloride copolymers.

3. A lateral emitting optical fiber according to claim 2, wherein said core material comprises a methacrylic polymer.

4. A lateral emitting optical fiber according to claim 1, wherein said zinc oxide particles are present at 0.15-30 wt % based on the weight of the clad material.

5. A lateral emitting optical fiber according to claim 1, wherein said clad material contains light scattering particles other than said zinc oxide particles, and wherein said zinc oxide particles are present in an amount such that the value of Y according to the following formula is 0.1-3.0 in a single layer or in an X-layered multilayer clad material.
Y=(wt % of the sum of zinc oxide particles and light scattering particles other than zinc oxide particles (light scattering particles) in layer 1×thickness of layer 1 (mm))+(wt % of light scattering particles in layer 2×thickness of layer 2 (mm))+ . . . (wt % of light scattering particles in layer X×thickness of layer X (mm))

6. A lateral emitting optical fiber according to claim 5, wherein said zinc oxide particles are present in an amount such that the value of Y according to the aforementioned formula is 0.2-1.0 in a single layer or in an X-layered multilayer clad material.

7. A lateral emitting optical fiber according to claim 1, wherein said zinc oxide particles have particle sizes of 0.1-10 μm.

8. A lateral emitting optical fiber according to claims 1, which is composed only of a core material and a clad material.

9. A light emitting device which comprises
a lateral emitting optical fiber according to claims 1, and
a light source which introduces light from at least one end of said optical fiber.

10. A light emitting device according to claim 9, wherein light is introduced from both ends of said optical fiber.
